(19) United States
(12) Patent Application Publication
(10) Pub. No.: US 2013/0030085 A1
(43) Pub. Date: Jan. 31, 2013

(54) ONE-PACK TYPE RESIN COMPOSITION FOR USE IN BACKING

(71) Applicants: Koichiro Higasa, Yokkaichi-shi (JP); Minoru Kato, Yokkaichi-shi (JP)

(72) Inventors: Koichiro Higasa, Yokkaichi-shi (JP); Minoru Kato, Yokkaichi-shi (JP)

(73) Assignee: Emulsion Technology Co., Ltd., Yokkaichi-shi (JP)

(21) Appl. No.: 13/640,062

(22) PCT Filed: Apr. 14, 2010
(86) PCT No.: PCT/JP2010/056681

§ 371 Date: Oct. 9, 2012

(51) Int. Cl. C08L 63/10; C08K 3/22

(52) U.S. Cl. 523/457

(57) ABSTRACT

Provided is the one-pack type backing resin composition which exhibits excellent fall-off resistance, excellent storage stability, and high flame retardancy. A one-pack type backing resin composition includes 100 parts by mass of (A) a (meth)acrylic polymer, and 50 to 500 parts by mass of (B) a flame retardant, the (meth)acrylic polymer (A) being produced by emulsion polymerization of a monomer component, and having a solvent-insoluble content of 0 to 85 mass %, the monomer component including 0.5 to 25 mass % of (a) glycidyl methacrylate, 0.2 to 10 mass % of (b) an unsaturated carboxylic acid monomer, and 70 to 99.3 mass % of (c) an additional copolymerizable monomer (provided that (a)+(b)+(c)=100 mass %).

### TECHNICAL FIELD

The invention relates to a one-pack type backing resin composition. More specifically, the invention relates to a one-pack type backing resin composition that exhibits excellent storage stability, excellent fall-off resistance, and excellent slow burning property.

### BACKGROUND ART

In recent years, measures against fires have become an important subject along with an increase in the number of automobiles and close packing of urban dwellings. In particular, flame retardancy has been strongly desired for interior materials used for automobiles and houses, and various flame retardant techniques have been proposed.

For example, a textile product (e.g., carpet) used for the interior of automobiles is provided with flame retardancy by backing the textile product using a slow burning or flame-retardant backing resin composition.

A flame-retardant vinyl chloride-based or vinylidene chloride-based emulsion that contains a halogen has been used as the backing resin composition. However, such a flame-retardant emulsion generates toxic gas (e.g., halogen gas) that is very harmful to the human body during combustion (e.g., fire or thermal recycling), and causes air pollution, a deterioration in an incinerator, and the like.

In order to solve the above problems, a slow burning aqueous backing resin composition in which an epoxy-based resin is compounded with an ethylene-based polymer aqueous emulsion (see Patent Document 1, for example), and a backing resin composition in which a flame retardant is compounded with a glycidyl group-containing polymer (see Patent Document 2, for example), have been proposed.

### RELATED-ART DOCUMENT

### Patent Document

Patent Document 1: JP-A-10-237764
Patent Document 2: JP-A-2007-204559

The above backing resin compositions can suppress generation of toxic gas (e.g., halogen gas). However, a slow burning aqueous backing resin composition in which an epoxy-based resin is compounded with an ethylene-based polymer aqueous emulsion (see Patent Document 1, for example) exhibits insufficient storage stability. Moreover, it is required to be a two-pack configuration in which the epoxy resin is added immediately before use. That leads poor workability. A backing resin composition in which a flame retardant is simply compounded with a glycidyl group-containing polymer (see Patent Document 2, for example) does not exhibit sufficient slow burning property and fall-off resistance.

A backing resin composition that utilizes an emulsion that contains glycidyl methacrylate has an epoxy group that is derived from glycidyl methacrylate in the skeleton of the polymer contained in the emulsion. The epoxy group has a tendency of increasing of the gel content (hereinafter referred to as “solvent-insoluble content”) via a crosslinking reaction. Therefore, a textile product that is backed using a backing resin composition of this type tends to show a fall-off phenomenon, and generate dust when people repeatedly walk on the textile product, for example. This makes it difficult to use the textile product for a long time.

In view of the above situation, an object of the invention is to provide a one-pack type backing resin composition that exhibits excellent storage stability, excellent fall-off resistance, and excellent slow burning property.

### SUMMARY OF THE INVENTION

According to the invention which is completed in order to solve the above problem, the following one-pack type backing resin composition is provided.
[1] A one-pack type backing resin composition comprising 100 parts by mass of (A) a (meth)acrylic polymer, and 50 to 500 parts by mass of (B) a flame retardant, the (meth)acrylic polymer (A) being produced by emulsion polymerization of a monomer component, and having a solvent-insoluble content of 0 to 85 mass %, the monomer component including 0.5 to 25 mass % of (a) glycidyl methacrylate, 0.2 to 10 mass % of (b) an unsaturated carboxylic acid monomer, and 70 to 99.3 mass % of (c) an additional copolymerizable monomer (provided that (a)+(b)+(c)=100 mass %).
[2] The one-pack type backing resin composition according to [1], further comprising 0.2 to 10 parts by mass of (C) a block isocyanate.
[3] The one-pack type backing resin composition according to [1] or [2], wherein the flame retardant (B) is at least one flame retardant selected from a group consisting of ammonium phosphate, aluminum hydroxide, magnesium hydroxide, and ammonium polyphosphate.

The invention thus provides a one-pack type backing resin composition that exhibits excellent storage stability, excellent fall-off resistance, and excellent slow burning property.

### MODE FOR CARRYING OUT THE INVENTION

Exemplary embodiments of the invention are described in detail below. Note that the invention is not limited to the following exemplary embodiments. Various modifications, improvements, and the like may be made of the following exemplary embodiments without departing from the scope of the invention based on the knowledge of a person skilled in the art.

### 1. One-Pack Type Backing Resin Composition

A one-pack type backing resin composition according to the invention includes 100 parts by mass of (A) a (meth)acrylic polymer, and 50 to 500 parts by mass of (B) a flame retardant. Further in the backing resin composition according to the invention, the (meth)acrylic polymer (A) is characterized by being produced by emulsion polymerization of a monomer component, and having a solvent-insoluble content of 0 to 85 mass %, the monomer component including 0.5 to 25 mass % of (a) glycidyl methacrylate, 0.2 to 10 mass % of (b) an unsaturated carboxylic acid monomer, and 70 to 99.3 mass % of (c) an additional copolymerizable monomer (provided that (a)+(b)+(c)=100 mass %). Note that the glycidyl methacrylate (a) may be referred to as “component (a)”, the unsaturated carboxylic acid monomer (b) may be referred to as “component (b)”, and the additional copolymerizable monomer (c) may be referred to as “component (c)”.

The term “one-pack type backing resin composition” used herein refers to a backing resin composition that can be stored in a state in which the backing resin composition includes all of the components necessary for backing a textile product, for example. In contrast, the term “two-pack type backing resin composition” used herein refers to a backing resin composition that includes a component (e.g., epoxy crosslinking agent) that must be mixed immediately before use.

The monomer component that includes the components (a) to (c) may be subjected to emulsion polymerization in the presence of an emulsifier, water, a chain transfer agent, and an initiator, for example (the details thereof are described later).

The (meth)acrylic polymer (A) may be used in a state of an emulsion produced by emulsion polymerization of the monomer component that includes the components (a) to (c).

The glycidyl methacrylate (a) is a crosslinkable monomer. When the monomer component ((a)+(b)+(c)=100 mass %) that is subjected to emulsion polymerization for producing the (meth)acrylic polymer (A) includes 0.5 mass % or more of the glycidyl methacrylate (a), the resulting one-pack type backing resin composition exhibits slow burning property. When the monomer component ((a)+(b)+(c)=100 mass %) that is subjected to emulsion polymerization for producing the (meth)acrylic polymer (A) includes 25 mass % or less of the glycidyl methacrylate (a), high polymerization stability is maintained, so that the (meth)acrylic polymer (A) can be easily produced by emulsion polymerization.

It is preferable that the monomer component ((a)+(b)+(c)=100 mass %) that is subjected to emulsion polymerization for producing the (meth)acrylic polymer (A) include 2 to 12 mass % of the glycidyl methacrylate (a) in order to ensure ease of production due to high polymerization stability, and ensure that the resulting one-pack type backing resin composition reliably exhibits slow burning property.

The unsaturated carboxylic acid monomer (b) is an unsaturated carboxylic acid monomer and a monoester thereof. Specific examples of the unsaturated carboxylic acid monomer (b) are described later. When the monomer component ((a)+(b)+(c)=100 mass %) that is subjected to emulsion polymerization for producing the (meth)acrylic polymer (A) includes 0.2 mass % or more of the unsaturated carboxylic acid monomer (b), the amount of aggregates rarely increases. When the monomer component ((a)+(b)+(c)=100 mass %) that is subjected to emulsion polymerization for producing the (meth)acrylic polymer (A) includes 10 mass % or less of the unsaturated carboxylic acid monomer (b), emulsion polymerization progresses smoothly, and an emulsion that includes the (meth)acrylic polymer (A) produced by emulsion polymerization does not have high viscosity, and can be easily mixed with the flame retardant (B) and the like.

It is preferable that the monomer component ((a)+(b)+(c)=100 mass %) that is subjected to emulsification polymerization for producing the (meth)acrylic polymer (A) include 2 to 4 mass % of the unsaturated carboxylic acid monomer (b) in order to ensure ease of production due to smooth emulsion polymerization, and more reliably ensure easy mixing with the flame retardant and the like.

The additional copolymerizable monomer (c) is a monomer that is copolymerizable with the glycidyl methacrylate (a) and the unsaturated carboxylic acid monomer (b). An alkyl (meth)acrylate that includes an alkyl group having 1 to 12 carbon atoms and the like (specific examples thereof are described later) are preferable as the additional copolymerizable monomer (c) since the slow burning property of the one-pack type backing resin composition can be further improved.

The (meth)acrylic polymer (A) has a low solvent-insoluble content of 0 to 85 mass %. This ensures that the one-pack type backing composition according to one embodiment of the invention exhibits excellent flame retardancy, and exhibits excellent adhesion to fibers (i.e., exhibits excellent fall-off resistance). It is preferable that the (meth)acrylic polymer (A) have a solvent-insoluble content of 10 to 85 mass %, and more preferably 20 to 80 mass %.

The term “solvent-insoluble content” used herein in connection with the (meth)acrylic polymer (A) refers to the tetrahydrofuran-insoluble content in the whole (meth)acrylic polymer (A). More specifically, a film (W₁ (mg)) prepared by drying the acrylic polymer at room temperature (25° C.) for 3 days is immersed in tetrahydrofuran for 16 hours. Then, a tetrahydrofuran-insoluble component contained in the film is collected by filtration or the like, and dried at room temperature (25° C.) for 24 hours, and the mass (W₂ (mg)) of the tetrahydrofuran-insoluble component is measured. The solvent-insoluble content in the (meth)acrylic polymer (A) is calculated from the masses W₁ and W₂ using the following expression (1). Note that the solvent-insoluble content is also referred to as a gel fraction.

Solvent-insoluble content=W₂/W₁×100 (1)

The term “fall-off” phenomenon used herein refers to a phenomenon in which the flame retardant and the inorganic filler fall off due to the pressure, deformation, and the like of the backing agent. The fall-off phenomenon occurs due to insufficient binding capacity of the binder. The fall-off phenomenon is normally indicated by the abrasion rate determined using a carpet abrasion tester. The abrasion rate determined by the carpet abrasion tester above is determined by subjecting a sample to an abrasion test at a temperature of 23° C. and a humidity of 50% RH using a No. 818 carpet abrasion tester (manufactured by Toyo Seiki Seisaku-Sho, Ltd.) (abrasive wheel: gear abrasive wheel, load: 0.25 kg, table rotational speed: 70 rpm, abrasive wheel vertical motion: 97 cpm, abrasive wheel fall height: about 20 mm, dust collection distance: 1 mm, number of rotations: 500) while applying impact by the vertical motion of the abrasive wheel to measure the mass (mg) of the backing material that falls off from the sample. The case where the mass of the backing material that has fallen off from the sample is small is called fall-off is low. The lower fall-off resistance is determined to be excellent.

The flame retardant (B) provides the one-pack type backing resin composition with flame retardancy. When the one-pack type backing resin composition includes the flame retardant (B) in an amount of 50 parts by mass or more based on 100 parts by mass of the (meth)acrylic polymer (A), the one-pack type backing resin composition exhibits sufficient slow burning property. When the amount of the flame retardant (B) is 500 parts by mass or less, the one-pack type backing resin composition exhibits a good handling capability due to moderate viscosity. The amount of the flame retardant (B) is preferably 100 to 300 parts by mass, and more preferably 120 to 200 parts by mass, based on 100 parts by mass of the (meth)acrylic polymer (A) so that the one-pack type backing resin composition exhibits sufficient slow burning property, and exhibits a good handling capability.

The one-pack type backing resin composition according to the invention may be used for backing a textile product (e.g., carpet) used for the interior of an automobile or a house. A textile product that is backed using the one-pack type backing resin composition according to the invention exhibits slow burning property.

Note that the term “slow burning property” used herein refers to the “slow burning property” used as a flammability class in JIS D 1201-1977 (“Test Method for Flammability of Organic Interior Materials for Automobiles”). More specifically, the term “slow burning property” used herein means that a material that has ignited in air in a windless state continues to burn slowly at a burning rate of 10 cm/min or less after the ignition source has been removed. The flammability test method defined in JIS D 1201-1977 conforms to the combustion test defined in FMVSS (Federal Motor Vehicle Safety Standard)-302.

Each component of the one-pack type backing resin composition according to the invention is described in detail below.

### (Meth)acrylic Polymer (A)

### (1) Emulsion Polymerization for Producing (Meth)acrylic Polymer (A)

The details of emulsion polymerization of the monomer component ((a)+(b)+(c)) for producing the (meth)acrylic polymer (A) are described below.

Examples of the emulsifier used for emulsion polymerization for producing the (meth)acrylic polymer (A) include anionic emulsifiers such as alkyl sulfate salts, alkylaryl sulfate salts, alkyl phosphate salts, and fatty acid salts, reactive emulsifiers such as Neopelex G25, Latemul S-180A, Emal 10N (manufactured by Kao Corporation), Eleminol JS-2 (manufactured by Sanyo Chemical Industries, Ltd.), Aqualon KH-10 (manufactured by Dai-ichi Kogyo Seiyaku Co., Ltd.), Adeka Reasoap SE-10N, Adeka Reasoap SR-10 (manufactured by Adeka Corporation), Antox MS-60 (manufactured by Nippon Nyukazai Co., Ltd.), and Surfiner FP-120 (manufactured by Toho Chemical Industry Co., Ltd.), and the like (trade name). These emulsifiers may be used either alone or in combination.

It is preferable that the (meth)acrylic polymer (A) included in the one-pack type backing resin composition according to the invention is a polymer produced by emulsion polymerization using an anionic emulsifier or a reactive emulsifier. In this case, the (meth)acrylic polymer (A) exhibits excellent storage stability, and exhibits stable miscibility with the flame retardant (B).

The emulsifier is normally used for emulsion polymerization in an amount of 0.5 to 10 parts by mass, and preferably 1 to 5 parts by mass, based on 100 parts by mass of the monomer component ((a)+(b)+(c)) that is subjected to emulsion polymerization for producing the (meth)acrylic polymer (A).

When the emulsifier is used in an amount of 0.5 parts by mass or more based on 100 parts by mass of the monomer component ((a)+(b)+(c)) that is subjected to emulsion polymerization for producing the (meth)acrylic polymer (A), sufficient emulsification can be achieved while achieving excellent polymerization stability. When the emulsifier is used in an amount of 10 parts by mass or less based on 100 parts by mass of the monomer component ((a)+(b)+(c)) that is subjected to emulsion polymerization for producing the (meth)acrylic polymer (A), particles obtained by polymerization have a sufficient particle size, so that the applicability is improved.

The chain transfer agent reduces the solvent-insoluble content in the (meth)acrylic polymer (A) during emulsion polymerization for producing the (meth)acrylic polymer (A). Therefore, the chain transfer agent may be used to adjust the solvent-insoluble content in the (meth)acrylic polymer (A) to 0 to 85 mass %.

Examples of the chain transfer agent include halogenated hydrocarbons (e.g., carbon tetrachloride, chloroform, and bromoform), mercaptans (e.g., n-dodecylmercaptan, t-dodecylmercaptan, n-octylmercaptan, and alkyl thioglycolates such as 2-ethylhexyl thioglycolate), xanthogens (e.g., dimethyl xanthogen disulfide and diisopropyl xanthogen disulfide), terpenes (e.g., dipentene and terpinolene), 1,1-diphenylethylene, unsaturated cyclic hydrocarbons (e.g., 9,10-dihydroanthracene, 1,4-dihydronaphthalene, indene, and 1,4-cyclohexadiene), unsaturated heterocyclic compounds (e.g., xanthene and 2,5-dihydrofuran), an α-methylstyrene dimer (i.e., an α-methylstyrene dimer that includes at least one of (I) 2,4-diphenyl-4-methyl-1-pentene, (II) 2,4-diphenyl-4-methyl-pentene, and (III) 1,1,3-trimethyl-3-phenylindane (preferably (I)/{(II)+(III)}=40 to 100/0 to 60 (mass ratio))), and the like. These chain transfer agents may be used either alone or in combination.

The chain transfer agent may be added to the emulsion polymerization system at one time, batchwise, continuously, a combination thereof, or the like. The chain transfer agent is preferably used in an amount of 5 parts by mass or less based on 100 parts by mass of the monomer component ((a)+(b)+(c)) that is subjected to emulsion polymerization for producing the (meth)acrylic polymer (A).

Examples of the initiator that may be used for emulsion polymerization for producing the (meth)acrylic polymer (A) include water-soluble initiators such as persulfates (e.g., potassium persulfate, sodium persulfate, and ammonium persulfate), hydrogen peroxide, t-butyl hydroperoxide, t-butylperoxymaleic acid, succinic peroxide, and 2,2′-azobis[2-N-benzylamidino]propane hydrochloride; oil-soluble initiators such as benzoyl peroxide, cumene hydroperoxide, diisopropyl peroxydicarbonate, cumyl peroxyneodecanoate, cumyl peroxyoctoate, and azobisisobutyronitrile; redox initiators that utilize a reducing agent such as acidic sodium hydrogen sulfite, ferrous sulfate, tetraethylenepentamine, or ascorbic acid; and the like.

The initiator is normally used in an amount of 0.01 to 3 parts by mass, and preferably 0.1 to 1 part by mass, based on 100 parts by mass of the monomer component ((a)+(b)+(c)) that is subjected to emulsion polymerization for producing the (meth)acrylic polymer (A), so that the following effects can be more reliably obtained. When the initiator is used in an amount of 0.01 parts by mass or more based on 100 parts by mass of the monomer component ((a)+(b)+(c)) that is subjected to emulsion polymerization for producing the (meth)acrylic polymer (A), sufficient polymerization stability can be achieved while suppressing occurrence of aggregates. Moreover, the amount of monomer that remains unreacted decreases. When the initiator is used in an amount of 3 parts by mass or less based on 100 parts by mass of the monomer component ((a)+(b)+(c)) that is subjected to emulsion polymerization for producing the (meth)acrylic polymer (A), an excessive increase in rate of reaction does not occur.

### (2) Glass Transition Temperature of (Meth)acrylic Polymer (A)

The glass transition temperature of the (meth)acrylic polymer (A) is preferably −50 to 100° C., more preferably −30 to 80° C. or less, and particularly preferably −20 to 70° C. When the glass transition temperature of the (meth)acrylic polymer (A) is −50° C. or more, the one-pack type backing resin composition exhibits sufficient slow burning property. A (meth)acrylic polymer (A) having a glass transition temperature of 100° C. or less can be easily produced by polymerization.

Note that the term “glass transition temperature” used herein refers to a value measured by the following method.

About 5 g of an aqueous dispersion containing the (meth)acrylic polymer (A) is thinly applied to a glass plate, and dried at 25° C. for 7 days to obtain a dry film.

The glass transition temperature of the dry film is measured using a differential scanning calorimeter (DSC) (e.g., DSC manufactured by Rigaku Corporation) under conditions of temperature increase rate: 20° C./min, atmosphere: nitrogen, and amount of sample: 20 mg.

### (3) Unsaturated Carboxylic Acid Conomer (b)

Examples of the unsaturated carboxylic acid monomer (b) include unsaturated carboxylic acids such as acrylic acid, methacrylic acid, crotonic acid, cinnamic acid, maleic acid, maleic anhydride, fumaric acid, itaconic acid, itaconic acid anhydride, and tetraconic acid, monoesters of saturated carboxylic acid monomers such as monomethyl maleate, monoethyl maleate, monomethyl itaconate, monoethyl itaconate, phthalic acid monohydroxyacrylate, mono-2-acryloyloxyethyl hexahydrophthalate, and mono-2-methacryloyloxyethyl hexahydrophthalate, free carboxyl group-containing esters such as a monoester of a non-polymerizable polycarboxylic acid (e.g., phthalic acid, succinic acid, or adipic acid) and a hydroxyl group-containing unsaturated compound (e.g., allyl alcohol, methallyl alcohol, 2-hydroxyethyl acrylate, or 2-hydroxyethyl methacrylate), and the like. These unsaturated carboxylic acid monomers may be used either alone or in combination.

It is preferable to use acrylic acid or methacrylic acid as the unsaturated carboxylic acid monomer (b) since the resulting one-pack type backing resin composition exhibits excellent storage stability.

### (4) Additional Copolymerizable Monomer (c)

Examples of the alkyl (meth)acrylate that includes an alkyl group having 1 to 12 carbon atoms that may be used as the additional copolymerizable monomer (c) include esters of (meth)acrylic acid and a linear or branched fatty alcohol, such as methyl(meth)acrylate, ethyl(meth)acrylate, butyl(meth)acrylate, methyl(meth)acrylate, ethyl(meth)acrylate, butyl(meth)acrylate, isobutyl(meth)acrylate, t-butyl(meth)acrylate, pentyl(meth)acrylate, isoamyl(meth)acrylate, hexyl(meth)acrylate, cyclohexyl(meth)acrylate, heptyl(meth)acrylate, octyl(meth)acrylate, isooctyl(meth)acrylate, 2-ethylhexyl(meth)acrylate, nonyl(meth)acrylate, isononyl(meth)acrylate, decyl(meth)acrylate, isodecyl(meth)acrylate, undecyl(meth)acrylate, and dodecyl(meth)acrylate; and the like. These compounds may be used either alone or in combination.

Among alkyl(meth)acrylates that includes an alkyl group having 1 to 12 carbon atoms above, it is preferable to use methyl methacrylate, butyl acrylate, and/or 2-ethylhexyl(meth)acrylate as the additional copolymerizable monomer (c) since these compounds are easily available, and the hardness of the (meth)acrylic polymer (A) produced by emulsion polymerization can be adjusted to the desired value.

The content of the alkyl (meth)acrylate that includes an alkyl group having 1 to 12 carbon atoms used as the additional copolymerizable monomer (c) in the monomer component ((a)+(b)+(c)=100 mass %) that is subjected to emulsion polymerization for producing the (meth)acrylic polymer (A) is preferably 70 to 99.3 mass %. When the content of the alkyl (meth)acrylate that includes an alkyl group having 1 to 12 carbon atoms is 70 mass % or more, the one-pack type backing resin composition exhibits improved texture as the backing material. When the content of the alkyl (meth)acrylate that includes an alkyl group having 1 to 12 carbon atoms is 99.3 mass % or less, the one-pack type backing resin composition exhibits improved adhesion to fibers.

A monomer other than the alkyl (meth)acrylate that includes an alkyl group having 1 to 12 carbon atoms may also be used as the additional copolymerizable monomer (c). Examples of such a monomer include aromatic vinyl monomers such as styrene, α-methylstyrene, 4-methylstyrene, 2-methylstyrene, 3-methylstyrene, 4-methoxystyrene, 2-hydroxymethylstyrene, 4-ethylstyrene, 4-ethoxystyrene, 3,4-dimethylstyrene, 3,4-diethylstyrene, 2-chlorostyrene, 3-chlorostyrene, 4-chloro-3-methylstyrene, 4- t-butylstyrene, 2,4-dichlorostyrene, 2,6-dichlorostyrene, and 1-vinylnaphthalene; vinyl monomers such as vinyl acetate; other polyfunctional monomers such as divinylbenzene; acid amide compounds such as (meth)acrylamide, N-methylol(meth)acrylamide, N-methoxymethyl(meth)acrylamide, N-butoxymethyl(meth)acrylamide, N,N′-methylenebisacrylamide, diacetoneacrylamide, maleic acid amide, and maleimide; vinyl cyanide compounds such as acrylonitrile and methacrylonitrile; piperidine-based monomers such as 4-(meth)acryloyloxy-2,2,6,6-tetramethylpiperidine, 4-(meth)acryloylamino-2,2,6,6-tetramethylpiperidine, and 4-(meth)acryloyloxy-1,2,2,6,6-pentamethylpiperidine; dicaprolactone; and the like. These monomers may be used as the additional copolymerizable monomer (c) in combination with the alkyl (meth)acrylate that includes an alkyl group having 1 to 12 carbon atoms.

The one-pack type backing resin composition according to the invention that has the above features may have the following configuration.

It is preferable that the one-pack type backing resin composition according to the invention include 100 parts by mass of the (meth)acrylic polymer (A), 50 to 500 parts by mass of the flame retardant (B), and 0.2 to 10 parts by mass of (C) a block isocyanate. When the one-pack type backing resin composition further includes 0.2 parts by mass or more of the block isocyanate (C), the one-pack type backing resin composition exhibits further improved slow burning property. The production cost can be reduced by limiting the amount of the block isocyanate (C) to 10 parts by mass or less. The block isocyanate (C) undergoes a crosslinking reaction to provide the one-pack type backing resin composition with excellent slow burning property.

Examples of the block isocyanate (C) include block products of a Biuret-type addition product, an isocyanuric ring-type addition product, and a polyhydric alcohol addition product, and the like (e.g., isophorone diisocyanate, tolylene diisocyanate, hexamethylene diisocyanate, xylylene diisocyanate, 4,4′-diphenylmethane diisocyanate, and 4,4′-methylenebis(cyclohexylisocyanate)).

It is preferable to use a tolylene diisocyanate-based block product, a 4,4′-diphenylmethane diisocyanate-based block product, and the like that include an isocyanate group with relatively high reactivity as the block isocyanate (C) from the viewpoint of improving the drying capability and the productivity.

A blocking agent for the block isocyanate (C) may be commonly used blocking agent. Examples of a blocking agent for the block isocyanate (C) include phenol-based compounds, alcohol-based compounds, active methylene-based compounds, mercaptan-based compounds, acid amide-based compounds, lactam-based compounds, acid imide-based compounds, imidazole-based compounds, urea-based compounds, oxime-based compounds, amine-based compounds, and the like. Specific examples of the blocking agent include phenol-based compounds such as phenol, cresol, and ethylphenol, alcohol-based compounds such as propylene glycol monomethyl ether, ethylene glycol, benzyl alcohol, methanol, and ethanol, active methylene-based compounds such as dimethyl malonate and acetylacetone, mercaptan-based compounds such as butylmercaptan and dodecylmercaptan, acid amide-based compounds such as acetanilide and acetic acid amide, lactam-based compounds such as ε-caprolactam and δ-valerolactam, acid imide-based compounds such as succinimide and maleimide, oxime-based compounds such as acetaldoxime, acetoneoxime, and methyl ethyl ketoxime, and amine-based compounds such as diphenylaniline, aniline, and ethyleneimine

It is preferable to use methyl ethyl ketoxime, ε-caprolactam, and 2-ethylhexanol as the blocking agent from the viewpoint of availability and the dissociation temperature of the blocking agent.

It is preferable that the flame retardant (B) included in the one-pack type backing resin composition according to the invention is a flame retardant that substantially does not include a halogen-based composition. This ensures that the one-pack type backing resin composition does not generate toxic gas (e.g., halogen gas) during combustion (e.g., fire or thermal recycling). Note that the expression “substantially does not include a halogen-based composition” means that a small amount of halogen may be mixed into the flame retardant depending on the flame retardant production process.

A known flame retardant such as an aluminum-based compound, a magnesium-based compound, an antimony-based compound, a boron-based compound, a zirconium-based compound, or ammonium phosphate may be used as such a flame retardant (B).

It is preferable that the flame retardant (B) included in the one-pack type backing resin composition according to the invention is at least one flame retardant selected from the group consisting of ammonium phosphate, aluminum hydroxide, magnesium hydroxide, and ammonium polyphosphate.

A flame retardant that includes aluminum hydroxide or magnesium hydroxide does not burn, absorbs heat during decomposition, and releases water molecules having a large heat capacity upon decomposition to inhibit combustion. For example, aluminum hydroxide decomposes into aluminum oxide and water due to an increase in temperature during combustion. The decomposition reaction of aluminum hydroxide progresses endothermically.

Ammonium phosphate reacts with the flame retardancy provision target textile product or the like to produce a phosphate, and promotes carbonization of the textile product. Therefore, when the one-pack type backing resin composition includes ammonium phosphate as the flame retardant (B), even if a textile product treated using the one-pack type backing resin composition ignites, a fire does not spread over the textile product, and is put out promptly.

### Additives

The one-pack type backing resin composition according to the invention may include a surfactant. The surfactant improves the storage stability, applicability, and the like of the one-pack type backing resin composition. The one-pack type backing resin composition may include the surfactant in an amount of 0.5 to 10 parts by mass based on 100 parts by mass of the (meth)acrylic polymer (A).

When the amount of the surfactant is 0.5 parts by mass or more based on 100 parts by mass of the (meth)acrylic polymer (A), the mechanical stability of the one-pack type backing resin composition is improved. When the amount of the surfactant is 10 parts by mass or less based on 100 parts by mass of the (meth)acrylic polymer (A), it is possible to prevent a deterioration in water resistance of the one-pack type backing resin composition due to the hydrophilicity of the surfactant.

It is preferable that the one-pack type backing resin composition include the surfactant in an amount of 0.5 to 8 parts by mass, and more preferably 0.5 to 5 parts by mass, based on 100 parts by mass of the (meth)acrylic polymer (A), from the viewpoint of further improving the mechanical stability of the one-pack type backing resin composition.

Examples of the surfactant include alkylbenzenesulfonates, long-chain sulfosuccinates, polyacrylates, and the like.

Examples of a preferable commercially available surfactant include Neopelex G25 (manufactured by Kao Corporation), ALCOPOL-FA 35 (manufactured by Ciba Specialty Chemicals K.K.), and the like. These surfactants may be used either alone or in combination.

The emulsifier that is used for emulsion polymerization for producing the (meth)acrylic polymer (A) may fall within the surfactant.

It is preferable that the one-pack type backing resin composition according to the invention include a thickener. The thickener provides the one-pack type backing resin composition with viscosity (preferably thixotropy). The thickener suppresses dripping or the like when backing a textile product or the like to implement excellent applicability.

Examples of the thickener include polymer polysaccharides such as xanthan gum, polyacrylic acid, sodium polyacrylate, carboxymethyl cellulose (CMC), sodium carboxymethyl cellulose (CMCNa), polyvinyl alcohol (PVA), polyvinylpyrrolidone (PVP), a methyl vinyl ether-maleic anhydride copolymer, sodium alginate, propylene glycol alginate, pectin, xanthan gum, locust bean gum, guar gum, arabinogalactan, sodium hyaluronate, and the like.

It is preferable that the one-pack type backing resin composition according to the invention include the thickener in an amount of 0.01 to 5 parts by mass, and more preferably 0.1 to 5 parts by mass, based on 100 parts by mass of the (meth)acrylic polymer (A) in case the composition includes the thickener. When the amount of the thickener is 0.01 parts by mass or more based on 100 parts by mass of the (meth)acrylic polymer (A), the effect of the thickener can be reliably achieved. When the amount of the thickener is 5 parts by mass or less based on 100 parts by mass of the (meth)acrylic polymer (A), the viscosity of the one-pack type backing resin composition does not unduly increase, so that practical utility is ensured.

The one-pack type backing resin composition according to one embodiment of the invention may further include a coloring agent, a antiseptic, an antifungal agent, and the like.

### 2. Method for Preparing One-Pack Type Backing Resin Composition

The one-pack type backing resin composition according to the invention may be prepared by mixing and stirring 100 parts by mass of the (meth)acrylic polymer (A) produced by emulsion polymerization and 20 to 500 parts by mass of the flame retardant (B) optionally together with the block isocyanate (C).

Note that the (meth)acrylic polymer (A) may be used in a state of an emulsion (i.e., an emulsion that includes the (meth)acrylic polymer (A)) obtained by emulsion polymerization. In this case, the one-pack type backing resin composition is preferably prepared by mixing and stirring the emulsion that includes the (meth)acrylic polymer (A), the flame retardant (B), and the surfactant, and then, mixing and stirring the mixture with the block isocyanate (C) in accordance with the purpose. It is preferable that the block isocyanate (C) is dispersed in water in advance from the viewpoint of ease of the mixing operation.

### 3. Usage of One-Pack Type Backing Resin Composition

A textile product that is provided with slow burning property using the one-pack type backing resin composition according to the invention is preferably a textile product that does not generate toxic gas during a fire. Examples of such a textile product include those made of synthetic fibers produced using polyester, polypropylene, nylon, acrylic acid, or the like as the raw material, natural fibers (e.g., wool), mixed fibers of synthetic fibers and natural fibers, and the like.

A textile product that is backed using the one-pack type backing resin composition according to the invention may suitably be used as an automotive interior material (e.g., ceiling, door, or seat cover material), a deck or floor carpet material (e.g., needle-punched carpet), or the like.

When backing a textile product using the one-pack type backing resin composition according to the invention, it is preferable to apply the one-pack type backing resin composition to the textile product in an amount of 20 to 150 g/m² (based on the solid content), and more preferably 30 to 100 g/m² (based on the solid content), so that a backing layer formed by the one-pack type backing resin composition exhibits excellent slow burning property.

A textile product on which the backing layer is formed using the one-pack type backing resin composition exhibits slow burning property that is used as a flammability class in JIS D 1201-1977 (“Test Method for Flammability of Organic Interior Materials for Automobiles”).

If the application amount of the one-pack type backing resin composition is less than the above range, the textile product may exhibit insufficient slow burning property. If the application amount of the one-pack type backing resin composition exceeds the above range, a fall-off phenomenon or the like may occur, or the production cost may increase.

It is preferable that the one-pack type backing resin composition according to one embodiment of the invention have moderate viscosity before use so that an appropriate amount of the one-pack type backing resin composition can be applied to a textile product (e.g., carpet).

It is preferable that the one-pack type backing resin composition according to the invention have a viscosity at 25° C. of 1000 to 20,000 mPa·s, and more preferably 1500 to 5000 mPa·s. When the one-pack type backing resin composition has a viscosity at 25° C. of 1000 mPa·s or more, an appropriate amount of the one-pack type backing resin composition can be easily applied to a textile product (e.g., carpet) because its viscosity is not too low. When the one-pack type backing resin composition has a viscosity at 25° C. of 20,000 mPa·s or less, a backing process is facilitated due to excellent workability (i.e., applicability). Note that the viscosity of the one-pack type backing resin composition may be measured using a Brookfield rotational viscometer.

It is preferable that the one-pack type backing resin composition according to the invention have a solid content of 40 to 65 mass %, and more preferably 45 to 60 mass %. When the one-pack type backing resin composition has a solid content of 40 mass % or more, the drying capability and the handling capability are improved. When the one-pack type backing resin composition has a solid content of 65 mass % or less, excellent workability (i.e., applicability) can be maintained.

### EXAMPLES

The invention is further described below by way of examples. Note that the invention is not limited to the following examples. Note that the unit “parts” refers to “parts by mass”, and the unit “%” refers to “mass %” unless otherwise indicated.

Evaluation method

80 g/m² (based on the solid content) of the backing resin composition obtained in each example or comparative example was applied to a polyester needle-punched carpet (mass per unit area: 230 g/m²), and dried at 160° C. for 5 minutes. The carpet was cut to dimensions of 350×200 mm, and allowed to stand at a temperature of 20° C. and a humidity of 65% RH for 24 hours to prepare a sample.

### Evaluation of Slow Burning Property

The sample prepared by the above method was subjected to a combustion test (horizontal method) in accordance with FMVSS-302. The combustion test was performed ten times, and the average burning rate was calculated. A case where the burning rate was 10 cm/min or more was determined to be unacceptable.

### Fall-Off Resistance

The sample was subjected to an abrasion test at a temperature of 23° C. and a humidity of 50% RH using a No. 818 carpet abrasion tester (manufactured by Toyo Seiki Seisaku-Sho, Ltd.) (abrasive wheel: gear abrasive wheel, load: 0.25 kg, table rotational speed: 70 rpm, abrasive wheel vertical motion: 97 cpm, abrasive wheel fall height: about 20 mm, dust collection distance: 1 mm, number of rotations: 500) while applying impact by the vertical motion of the abrasive wheel to measure the mass (mg) of the backing material that falls off from the sample.

### Storage Stability

The viscosity of the backing resin composition obtained in each example or comparative example was measured to evaluate the storage stability. More specifically, the viscosity of the backing resin composition was measured immediately after preparation (hereinafter referred to as “initial viscosity”), and after allowing the backing resin composition to stand at 40° C. for 7 days (hereinafter referred to as “viscosity after 7-day storage”). A case where the ratio of the viscosity after 7-day storage to the initial viscosity (viscosity buildup ratio) was 130% or more was determined to be unacceptable. The viscosity of the backing resin composition was measured using a Brookfield rotational viscometer.

### Production of (Meth)acrylic Polymer (A)

In the examples and comparative examples, the following raw materials were used to produce the (meth)acrylic polymer (A).

### Glycidyl Methacrylate (a)

Glycidyl methacrylate (hereinafter referred to as GMA) manufactured by Mitsubishi Gas Chemical Company, Inc.

### Unsaturated Carboxylic Acid Monomer (b)

Acrylic acid (hereinafter referred to as AA) manufactured by Mitsubishi Chemical Corporation

### Additional Copolymerizable Monomer (c)

Methyl methacrylate (hereinafter referred to as MMA) manufactured by Mitsubishi Rayon Co., Ltd.
Butyl acrylate (special grade) (hereinafter referred to as BA) manufactured by Wako Pure Chemical Industries, Ltd.
Ethyl acrylate (special grade) (hereinafter referred to as EA) manufactured by Wako Pure Chemical Industries, Ltd.
Acrylonitrile (hereinafter referred to as AN) manufactured by Dia-Nitrix Co., Ltd.
Styrene (hereinafter referred to as ST) manufactured by Mitsubishi Chemical Corporation

### Initiator

Sodium persulfate (first grade) manufactured by Wako Pure Chemical Industries, Ltd.

### Emulsifier

Alkylbenzenesulfonate (Neopelex G25 (trade name)) manufactured by Kao Corporation
   Chain transfer agent
n-Dodecylmercaptan (first grade) manufactured by Wako Pure Chemical Industries, Ltd.

### Preparation of Backing Resin Composition

In the examples and comparative examples, the following raw materials were used to prepare the backing resin composition.

### Flame Retardant (B)

Aluminum hydroxide (B303 (trade name)) manufactured by Nippon Light Metal Co., Ltd.

### Surfactant

Alkylbenzenesulfonate (Neopelex G25 (trade name)) manufactured by Kao Corporation Long-chain sulfosuccinic acid (ALCOPOL-FA35 (trade name)) manufactured by Ciba Specialty Chemicals K.K.

### Block Isocyanate (C)

Aqueous dispersion of tolylene diisocyanate (TDI)-based methyl ethyl ketoxime block (Meicanate TP-120 (trade name)) manufactured by Meisei Chemical Works, Ltd.

### Thickener

Xanthan gum (Kelzan (trade name)) manufactured by Kelco Polyacrylic acid (Aron A-20P (trade name)) manufactured by Toagosei Co., Ltd.

### Crosslinking Agent

Epoxy crosslinking agent (Denacol EX-421 (trade name)) manufactured by Nagase ChemteX Corporation

### Example 1

A flask equipped with a stirrer, a reflux condenser, and a thermometer was charged with 40 parts of deionized water and 0.06 parts of an alkyl benzene sulfonate (emulsifier). The mixture was heated to 65° C.

Separately, 12 parts of GMA, 3 parts of AA, 47.4 parts of MMA, 27.9 parts of BA, 6 parts of AN, 3.7 parts of ST, 0.05 parts of n-dodecylmercaptan, and 1.25 parts of an alkyl benzene sulfonate (emulsifier) were dispersed (emulsified) in 50 parts of deionized water to prepare a preliminary emulsion.

The preliminary emulsion was added dropwise to the flask from a dropping funnel over 4 hours, and 0.3 parts of a 10% sodium persulfate aqueous (initiator) solution as initiator was added to the mixture to initiate polymerization.

The mixture was reacted at 65° C. for 4 hours, and then reacted at 80° C. for 2 hours to obtain an emulsion containing the (meth)acrylic polymer (A) (solid content: 50 mass %). The resulting polymer had a tetrahydrofuran-insoluble content of 22 mass % (“THF-insoluble content in polymer” in Table 1). The emulsifier contained in the emulsion also serves as the surfactant in the backing resin composition prepared in Example 1.

150 parts of aluminum hydroxide as flame retardant (B), 1.75 parts of an alkyl benzene sulfonate as surfactant, 0.7 parts of a long-chain sulfosuccinic acid (ALCOPOL-FA35 (trade name)) as surfactant, 0.6 parts of a 3% aqueous solution of xanthan gum (Kelzan (trade name)) as thickener, and 1.0 parts of polyacrylic acid (Aron A-20P (trade name)) as thickener were added to the emulsion containing 100 parts of the (meth)acrylic polymer (A). The mixture was sufficiently mixed and stirred to obtain a one-pack type backing resin composition (Example 1) containing a (meth)acrylic emulsion.

Note that the emulsion containing 100 parts of the (meth)acrylic polymer (A) used to prepare the one-pack type backing resin composition of Example 1 contained 1.31 parts of the emulsifier used for emulsion polymerization as a surfactant.

The burning rate, the fall-off amount, and the storage stability were evaluated using the resulting one-pack type backing resin composition. Table 1 shows the composition of the one-pack type backing resin composition of Example 1, and the evaluation results.

TABLE 1

| | | Example | Example | Example | Example | Comparative | Comparative | Comparative |
|---|---|---|---|---|---|---|---|---|
| Component (parts) | | 1 | 2 | 3 | 4 | Example 1 | Example 2 | Example 3 |
| (A) Acrylic polymer | | 100 | 100 | 100 | 100 | 100 | 100 | 100 |
| (a) Glycidyl methacrylate (GMA) | | 12 | 12 | 12 | 12 | 12 | 12 | 0 |
| (b) Unsaturated carboxylic acid monomer (AA) | | 3 | 3 | 3 | 3 | 3 | 3 | 3 |
| (c) Ethyl acrylate (EA) | | 0 | 48 | 0 | 0 | 0 | 0 | 0 |
| (c) Methyl methacrylate (MMA) | | 47.4 | 27.3 | 47.4 | 47.4 | 47.4 | 47.4 | 59.4 |
| (c) Butyl acrylate (BA) | | 27.9 | 0 | 27.9 | 27.9 | 27.9 | 27.9 | 27.9 |
| (c) Acrylonitrile (AN) | | 6 | 6 | 6 | 6 | 6 | 6 | 6 |
| (c) Styrene (ST) | | 3.7 | 3.7 | 3.7 | 3.7 | 3.7 | 3.7 | 3.7 |
| (d) Chain transfer agent: n-dodecylmercaptan | | 0.05 | 0.1 | 0.05 | 0.05 | 0 | 0.05 | 0.05 |
| (B) Flame retardant: aluminum hydroxide | | 150 | 150 | 150 | 150 | 150 | 150 | 150 |
| Surfactant (total) | | 3.76 | 3.76 | 3.76 | 3.76 | 3.76 | 3.76 | 3.76 |
| Alkyl benzene sulfonate | | 1.75 | 1.75 | 1.75 | 1.75 | 1.75 | 1.75 | 1.75 |
| Long-chain sulfosuccinic acid | | 0.7 | 0.7 | 0.7 | 0.7 | 0.7 | 0.7 | 0.7 |
| Alkyl benzene sulfonate (emulsifier) | | 1.31 | 1.31 | 1.31 | 1.31 | 1.31 | 1.31 | 1.31 |
| (C) Crosslinking agent: block isocyanate | | 0 | 0 | 0.5 | 3 | 0 | 0 | 0 |
| Epoxy crosslinking agent | | 0 | 0 | 0 | 0 | 0 | 3 | 0 |
| Thickener: Xanthan gum (3% aqueous solution) | | 0.6 | 0.6 | 0.6 | 0.6 | 0.6 | 0.6 | 0.6 |
| Polyacrylic acid | | 1 | 1 | 1 | 1 | 1 | 1 | 1 |
| THF-insoluble content (%) in polymer | | 82 | 63 | 82 | 82 | 97 | 82 | 26 |
| Type | | One-pack | One-pack | One-pack | One-pack | One-pack | Two-pack | One-pack |
| Burning rate (cm/min) | | 6.1 | 6.2 | 5.7 | 5.1 | 6.1 | 6.0 | 12.3 |
| Storage stability | Initial viscosity (mPa · s) | 4000 | 4100 | 4000 | 3900 | 4000 | 3800 | 4000 |
| | Viscosity after 7-day storage | 4200 | 4300 | 4400 | 4200 | 4300 | 8600 | 4400 |
| | (mPa · s) | | | | | | | |
| | Viscosity buildup ratio (%) | 105 | 104.9 | 110 | 107.7 | 107.5 | 226.3 | 110 |

| | | | | | | | |
|---|---|---|---|---|---|---|---|
| Fall-off amount (mg) | 156 | 141 | 122 | 115 | 385 | 151 | 178 |

### Example 2

A one-pack type backing resin composition (Example 2) was obtained in the same manner as in Example 1, except that the preliminary emulsion was prepared using 12 parts of GMA, 3 parts of AA, 27.3 parts of MMA, 48 parts of EA, 6 parts of AN, 3.7 parts of ST, and 0.1 parts of n-dodecylmercaptan.

The burning rate, the fall-off amount, and the storage stability were evaluated using the resulting one-pack type backing resin composition. Table 1 shows the composition of the one-pack type backing resin composition of Example 2, and the evaluation results.

### Example 3

A one-pack type backing resin composition (Example 3) was obtained in the same manner as in Example 1, except that 0.5 parts of an aqueous dispersion of a tolylene diisocyanate (TDI)-based methyl ethyl ketoxime block (Meicanate TP-120 (trade name)) was used as the block isocyanate (C). Table 1 shows the composition of the one-pack type backing resin composition of Example 3, and the evaluation results.

### Example 4

A one-pack type backing resin composition (Example 4) was obtained in the same manner as in Example 1, except that 3 parts of an aqueous dispersion of a tolylene diisocyanate (TDI)-based methyl ethyl ketoxime block (Meicanate TP-120 (trade name)) was used as the block isocyanate (C). Table 1 shows the composition of the one-pack type backing resin composition of Example 4, and the evaluation results.

### Comparative Example 1

A one-pack type backing resin composition (Comparative Example 1) was obtained in the same manner as in Example 1, except that n-dodecylmercaptan was not used.

The burning rate, the fall-off amount, and the storage stability were evaluated using the resulting one-pack type backing resin composition. Table 1 shows the composition of the one-pack type backing resin composition of Comparative Example 1, and the evaluation results.

### Comparative Example 2

A two-pack type backing resin composition (Comparative Example 2) was obtained in the same manner as in Example 1, except that an epoxy crosslinking agent (Denacol EX421 (trade name)) was used as the block isocyanate (C). In Comparative Example 2, since the viscosity of the backing resin composition increases due to a crosslinking reaction upon addition of the epoxy crosslinking agent, the epoxy crosslinking agent was added immediately before use (i.e., the backing resin composition of Comparative Example 2 is classified as a two-pack type backing resin composition).

The burning rate, the fall-off amount, and the storage stability were evaluated using the resulting two-pack type backing resin composition. Table 1 shows the composition of the two-pack type backing resin composition of Comparative Example 2, and the evaluation results.

### Comparative Example 3

A one-pack type backing resin composition (Comparative Example 3) was obtained in the same manner as in Example 1, except that the preliminary emulsion was prepared using no GMA, 3 parts of AA, 59.4 parts of MMA, 27.9 parts of BA, 6 parts of AN, 3.7 parts of ST, and 0.05 parts of n-dodecylmercaptan.

The burning rate, the fall-off amount, and the storage stability were evaluated using the resulting one-pack type backing resin composition. Table 1 shows the composition of the one-pack type backing resin composition of Comparative Example 3, and the evaluation results.

As shown in Table 1, the samples (needle-punched carpets) that were respectively backed using the one-pack type backing resin compositions of Examples 1 and 2 had a burning rate of 6.1 cm/min and 6.2 cm/min, respectively (i.e., exhibited good flame retardancy). The samples (needle-punched carpets) that were respectively backed using the one-pack type backing resin compositions of Examples 3 and 4 had a burning rate of 5.1 cm/min and 5.7 cm/min, respectively (i.e., exhibited excellent flame retardancy).

The one-pack type backing resin compositions of Examples 1 to 4 had a small viscosity buildup ratio, exhibited excellent storage stability, and exhibited excellent applicability (i.e., the slow burning property, the fall-off resistance, and the storage stability of the one-pack type backing resin compositions of Examples 1 to 4 were acceptable).

The sample that was backed using the one-pack type backing resin composition of Comparative Example 1 had poor fall-off resistance due to a large fall-off amount (i.e., the fall-off resistance of the one-pack type backing resin composition of Comparative Example 1 was unacceptable). The sample that was backed using the two-pack type backing resin composition of Comparative Example 2 showed an increase in viscosity and exhibited poor storage stability (i.e., the storage stability of the one-pack type backing resin composition of Comparative Example 2 was unacceptable). The sample that was backed using the one-pack type backing resin composition of Comparative Example 3 had a high burning rate (13 cm/min) and exhibited insufficient flame retardancy (i.e., the slow burning property of the one-pack type backing resin composition of Comparative Example 3 was unacceptable).

### INDUSTRIAL APPLICABILITY

The one-pack type backing resin composition according to the invention exhibits excellent fall-off resistance, excellent storage stability, and excellent slow burning property, and may be used for backing a carpet or the like used for the interior of an automobile, a house floor, and the like.

1. A one-pack type backing resin composition comprising 100 parts by mass of (A) a (meth)acrylic polymer, and 50 to 500 parts by mass of (B) a flame retardant, the (meth)acrylic polymer (A) being produced by emulsion polymerization of a monomer component, and having a solvent-insoluble content of 0 to 85 mass %, the monomer component including 0.5 to 25 mass % of (a) glycidyl methacrylate, 0.2 to 10 mass % of (b) an unsaturated carboxylic acid monomer, and 70 to 99.3 mass % of (c) an additional copolymerizable monomer (provided that (a)+(b)+(c)=100 mass %).

2. The one-pack type backing resin composition according to claim 1, further comprising 0.2 to 10 parts by mass of (C) a block isocyanate.

3. The one-pack type backing resin composition according to claim 1, wherein the flame retardant (B) is at least one flame retardant selected from a group consisting of ammonium phosphate, aluminum hydroxide, magnesium hydroxide, and ammonium polyphosphate.

4. The one-pack type backing resin composition according to claim 2, wherein the flame retardant (B) is at least one flame retardant selected from a group consisting of ammonium phosphate, aluminum hydroxide, magnesium hydroxide, and ammonium polyphosphate.
